(19) United States
(12) Patent Application Publication
(10) Pub. No.: US 2008/0005294 A1
(43) Pub. Date: Jan. 3, 2008

(54) METHOD AND SYSTEM FOR EXCHANGING MESSAGES USING A PRESENCE SERVICE

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/428,252

(22) Filed: Jun. 30, 2006

(51) Int. Cl. G06F 15/173

(52) U.S. Cl. 709/223

(57) ABSTRACT

A method and system are described for exchanging messages using a presence service. According to an exemplary embodiment, a method of exchanging messages via a presence service, includes receiving at least one of a presence status and a message sent from a first client of the presence service via a publish command capable of sending the presence status and message as integrated presence and messaging information. The publish command conforms to a transmission format providing a status element for carrying the presence status and an inbox element for carrying the message. A notification including at least one of the presence status and at least a portion of the message is sent to a second client of the presence service via a notify command capable of sending the notification in conformance with the transmission format.

### RELATED APPLICATIONS

This application is related to U.S. patent application Ser. No. 11/096,764, titled “System and Method for Utilizing A Presence Service to Facilitate Access to a Service or Application Over A Network,” filed on Mar. 31, 2005, (Attorney Docket No. 1-309), and U.S. Patent Application No. 11/160,612, titled “Method And Apparatus For Browsing Network Resources Using An Asynchronous Communications Protocol,” filed on Jun. 30, 2005, (Attorney Docket No. 1-328), each assigned to the same assignee as this application, the entire disclosures of which are incorporated here by reference.

### BACKGROUND

Presence services can be used to convey a user's presence on a network to other network users based on the user's connectivity to the network via a computing and/or communication device. Information describing users' presence on a network can be used by applications and/or other services to provide what are referred to here as “presence aware applications.”

One of today's more popular presence aware applications is instant messaging (or IM). Popular IM applications include Yahoo's YAHOO MESSENGER, Microsoft's MSN MESSENGER, and America Online's AOL INSTANT MESSENGER (or AIM). IM applications use presence services to allow users to determine whether other users (referred to by these applications as “friends” or “buddies”) are present on (e.g., connected to) a network. Presence services can also be used to determine a user's status (e.g., available, not available, and the like) and a communication address for communicating with a user. The communication address can include both a method of communicating with the user (e.g., via a telephone or email) and a corresponding contact address (e.g., a telephone number or email address).

The architecture, models, and protocols associated with IM and presence services are described, in general, in the documents “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. While the various presence aware IM applications described above may use proprietary architectures and protocols to implement their presence/IM service components, each of the applications use presence and IM architectures and protocols that are consistent with the models and protocols described in RFC 2778 and RFC 2779 in terms of features and function.

Today's instant messaging (IM) systems use separate protocols for IM and for presence as advocated by RFC 2778 and 2779. For example, RFC 3921 to Saint-Andre, titled “Extensible Messaging and Presence Protocol (XMPP): Instant Messaging and Presence” (October 2004), referred to here as “XMPP-IM.” describes two separate sets of command protocols for exchanging instant messages and presence information (e.g., using the separate <message> and <presence> protocol headers). The same separate protocol arrangement exists for Short Message Service (SMS) and Multimedia Message Service (MMS) systems—popular message services used in today's cellular networks that utilize presence services. Typically, these separate protocols operate on data/information that is also stored separately. A number of other presence-based applications exist, or are in development, that also use application-specific protocols in conjunction with a separate presence protocol to integrate presence services with the applications.

Using separate models and protocols for delivering IM and presence services has lead to several inefficiencies and disadvantages. First, applications that provide both IM and presence services require two protocol agents at each client device, at least two servers at each service point providing the IM/presence services, and two protocol command sets to deliver both the IM and presence services. This replication of infrastructure can make it difficult or impractical to integrate the storage of IM and presence data, placing additional constraints on the IM/presence infrastructure. Second, supporting two separate protocols increases the difficulty in securing the devices and network over which the IM and presence protocol commands flow. Finally, managing the traffic carried over a network that has to support the separate IM and presence commands sets becomes more challenging.

### SUMMARY

Accordingly, a method and system are disclosed for exchanging messages using a presence service. According to an exemplary embodiment, a method of exchanging messages via a presence service, includes receiving at least one of a presence status and a message sent from a first client of the presence service via a publish command capable of sending the presence status and message as integrated presence and messaging information. The publish command conforms to a transmission format providing a status element for carrying the presence status and an inbox element for carrying the message. A notification including at least one of the presence status and at least a portion of the message is sent to a second client of the presence service via a notify command capable of sending the notification in conformance with the transmission format.

According to another exemplary embodiment, a method of sending messages via a presence service includes generating, by a sender client of the presence service, a message destined for a recipient client of the presence service. The sender client sends at least one of a presence status and the message to the presence service via a publish command capable of sending the presence status and message as integrated presence and messaging information. The publish command conforms to a transmission format providing a status element for carrying the presence status and an inbox element for carrying the message.

According to another exemplary embodiment, a method of receiving messages via a presence service includes receiving, by a recipient client of the presence service, a notification including at least one of a presence status and a message from the presence service via a notify command capable of sending the notification as integrated presence and messaging information. The notify command conforms to a transmission format providing a status element for carrying the presence status and an inbox element for carrying the message. The message is identified and displayed by the recipient client when present in the notification.

According to yet another exemplary embodiment, a system for exchanging messages using a presence service includes a data store for storing integrated presence and messaging information. The system includes at least one presence server including the presence service and a network protocol stack component having a presence protocol layer for communicating with at least one presence service client. The presence service includes a publication handler component, operatively coupled to the data store, configured to receive at least one of a presence status and a message sent from a first client of the presence service via a publish command capable of sending the presence status and message as integrated presence and messaging information. The publish command conforms to a transmission format providing a status element for carrying the presence status and an inbox element for carrying the message. The system includes a notification handler component, operatively coupled to the publication hander component and the data store, configured to send a notification including at least one of the presence status and at least a portion of the message to a second client of the presence service via a notify command capable of sending the notification in conformance with the transmission format. A router component, operatively coupled to the publication and notification handler components and to the presence protocol layer of the network protocol stack component, is included in the system to route the publish and notify commands between the publication and notification handler components and the first and second presence service clients.

According to another exemplary embodiment, a client device for sending and receiving messages via a presence service includes a network protocol stack component having a presence protocol layer configured to communicate with the presence service. At least one graphical user interface (GUI) component is included in the client device to gather and present at least one of presence status information and messaging information. The client device includes a presentity component, operatively coupled to the at least one GUI component and the network protocol stack component. The presentity component is configured to send at least one of a presence status and a message to the presence service via a publish command capable of sending the presence status and message as integrated presence and messaging information. The publish command conforms to a transmission format providing a status element for carrying the presence status and an inbox element for carrying the message. The system includes a watcher component, operatively coupled to the at least one GUI component and the network protocol stack component. The watcher component is configured to receive a notification including at least one of a presence status and a message via a notify command capable of sending the notification in conformance with the transmission format.

According to still another exemplary embodiment, a data model for at least one of exchanging integrated presence and messaging information via a presence service and storing the integrated presence and messaging information in a data store includes a status element representing a presence status of at least one client of the presence service. The data model includes an inbox element representing a message for exchange between first and second clients of the presence service.

In another exemplary embodiment, a system for exchanging messages using a presence service includes means for storing integrated presence and messaging information. The system includes means for receiving at least one of a presence status and a message sent from a first client of the presence service as integrated presence and messaging information conforming to a transmission format providing a status element for carrying the presence status and an inbox element for carrying the message. The system includes means for sending a notification including at least one of the presence status and at least a portion of the message to a second client of the presence service in conformance with the transmission format.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 illustrates a system for exchanging messages using a presence service, according to an exemplary embodiment;

FIG. 2 illustrates a server device including a presence service for exchanging messages, according to an exemplary embodiment;

FIG. 3 illustrates a client device for exchanging messages using a presence service, according to an exemplary embodiment;

FIGS. 4A-4C illustrate signal flow diagrams for exchanging messages using a presence service, according to various exemplary embodiments;

FIGS. 5A-5C illustrate data models for exchanging and/or storing integrated presence and messaging information, according to various exemplary embodiments;

FIG. 6 is a flowchart illustrating a method for exchanging messages using a presence service, according to an exemplary embodiment;

FIG. 7 is a flowchart illustrating a method for sending messages using a presence service, according to an exemplary embodiment; and

FIG. 8 is a flowchart illustrating a method for receiving messages using a presence service, according to an exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

### Definitions

The following provides definitions for various terms used throughout this document.
Principal: A human or non-human user of a client, often considered to be the owner of a corresponding tuple.
Client: Refers to the client of the Presence/Messaging Service. Example clients of a presence service include a presentity and a watcher.
Client Device: Allows the operation of the client. In some contexts, this term is used synonymously with client.
Tuple: A data format typically structured and often hierarchically organized compatible for transport using a pub-sub/presence protocol in its “on-the-wire” data format (i.e., the data format used when information is being carried over a communication link, either wired or wireless). Tuples typically have identifiers that can serve as an address, allowing the tuples to be “addressable.”
   Tuples may also be stored in their “on-the-wire” format by a service or a client, but may be translated into equivalent storage formats suitable for processing in processor memory or storage in persistent storage, such as a database.
   A sub-tuple is a tuple which is a portion of another tuple, referred to as a “parent tuple.”
   A tuple element, or simply “element,” is a single addressable item in a tuple. An element may be simple or complex. Simple elements contain no sub-tuples. Complex elements contain sub-tuples.
Pub-Sub Protocol: A protocol minimally supporting a subscribe, notify, and publish command set, or their equivalents, as described in RFC 2778 and RFC 2779.
Pub-Sub Service: A service which uses a pub-sub protocol to send the current or most recent information detected or received. Pub-Sub services store data in tuples each of which has an address and is associated with an owner. A pub-sub service as described in this disclosure is distinguished from other services, sometimes referred to as “pub-sub,” that at least one of:
   Provide current and old data to a “subscriber,” typically by queuing messages.
   Provide “subscribers” with data based on specified query or topic criteria, rather than by tuple identifier or address.
Presence Protocol: A type of pub-sub protocol where the tuple data format includes at least a status element associated with the tuple's principal. This definition is consistent with that provided in RFC 2778. The status element need not be an explicit element of the tuple, but can be inferred from another element included in the tuple. The transmission of partial tuples may be allowed, thus not all publish or notify message may include status information or have a corresponding status element.
Presence Service: A pub-sub service as defined above where each tuple stored by the service contains an explicit or implicit status element.

### Pub-Sub and Presence Services and Protocols

Pub-sub services and protocols, as defined above, provide a pattern for communication and storage as do request-reply (such as the hypertext transport protocol, or HTTP) and direct event-based protocols and services. The loose coupling between senders and receivers of information in pub-sub-based communication systems provides flexibility over other communication architectures. As such pub-sub protocols and services provide a platform upon which many services can be provided, including services using request-reply and direct event based architectures. Pub-sub services and protocols support both centralized architectures and distributed architectures including pure peer-to-peer systems.

The most common services provided using a pub-sub architecture currently are presence services. Presence is a basic service that is required by, or enhances, other services. Since pub-sub provides a generic platform for providing applications and services, it is possible to move some of the services pub-sub supports, such as IM, from IM's current proxy-relay based architecture to a pub-sub architecture. Further it is possible to integrate it with a presence service as will be described in detail below.

This disclosure describes several embodiments for providing messaging including IM, SMS, and MMS integrated with presence services in a single system. Store and forward messaging systems, such as email, can be integrated in a similar manner when a non-pub-sub-based extension supporting what this disclosure refers to as archiving is added as described in greater detail below.

### Integrated Presence and Messaging Service

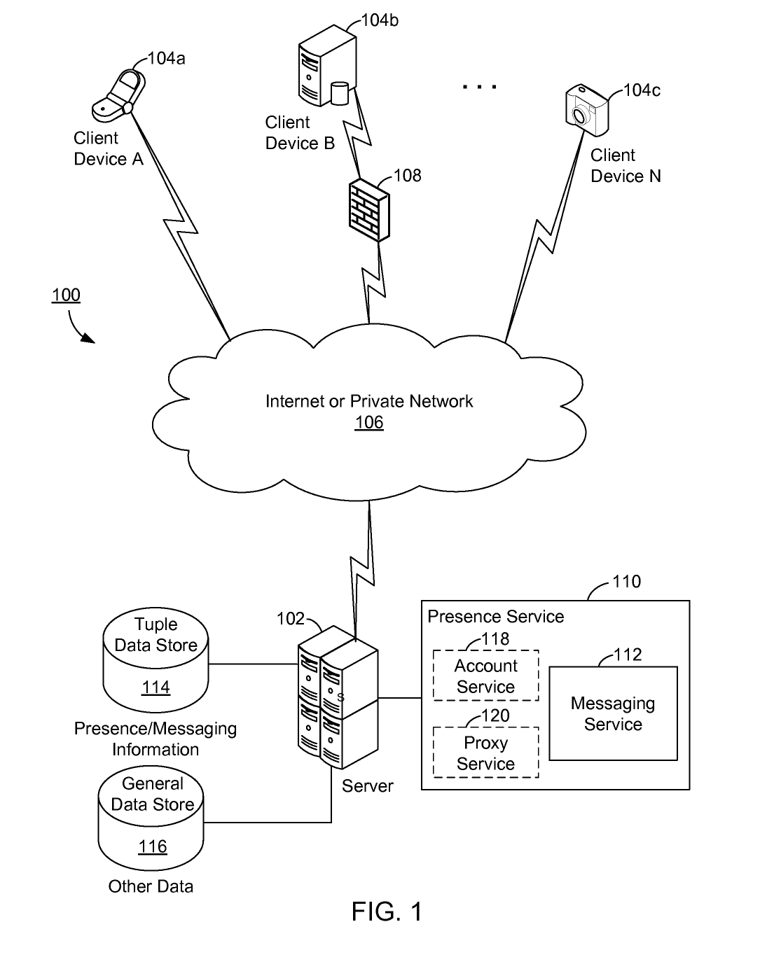

FIG. 1 illustrates an exemplary arrangement of a system for exchanging messages, such as IM messages, using a presence service. The system 100 includes a server 102 configured to exchange, and perhaps store, integrated presence and messaging information. The server 102 can host a presence service 110, including a messaging service 112, that allows the server 102 to exchange integrated presence and messaging information with any number of client devices 104 via a network 106. The presence 112 and messaging 114 services may use any pub-sub protocol that includes support for a presence protocol as defined in RFCs 2778 and 2779 discussed above. The client devices 104a, 104b, and 104c (collectively referred to here, singular or plural, as “client devices 104”) can include network-enabled personal computers (PCs), such as client device B 104b shown in FIG. 1, personal digital assistants (PDAs), cameras, such as client device N 104c, camera phones and cell phones, such as client device A 104a, and the like.

Although the presence service 110 is depicted in FIG. 1 as being hosted on a single, stand-alone, centralized server 102, it should be understood that the presence service 110 providing the messaging service 112 can be distributed across several servers (not shown) coupled to the network 106. Moreover, the presence service 110, and other functions provided by the server 102, can be incorporated, either in whole or in part, into any of the client devices 104 shown in the figure. Thus, arrangements from the fully centralized network architecture shown in FIG. 1 to a pure peer-to-peer architecture, in which each client device 104 can be associated with its own individual presence 110 and messaging 112 services, are within the scope of the subject matter described here. As such, the meaning of “server” used here does not strictly conform to the definition of a server provided in RFC 2778, as being an indivisible unit of a presence service. Nevertheless, the server 102 and the presence 110 and messaging 112 services are closely linked to one another and can be considered to perform one and the same function.

The server 102 can also include additional (optional) services, such as an account service 118 as shown in FIG. 1. The account service 118 can be configured to authenticate an identity of each of the client devices 104 (or principals associated with the devices) and to determine whether the devices 104 are authorized to exchange presence and messaging information with the services 110, 112 or other devices. The account service 118 can use rosters and/or privacy lists (well understood by those familiar with presence and IM services) to authorize and authenticate access to the presence 110 and messaging 112 services and other client devices, and to allow devices 104 to block communications from other devices or service providers via the presence 110 and messaging 112 services.

The roster and/or privacy list data can be stored in a data store, such as the general data store 116 shown coupled to the server 102 in FIG. 1. Multiple rosters and/or privacy lists can be maintained in the general data store 116 and used by the service 110. No new extensions to existing account service protocols for roster management is required to maintain the rosters or lists, however, the roster data can instead be included in presence information and carried by the presence protocol.

In another exemplary embodiment, a proxy service can be provided for allowing the presence and messaging information through a firewall associated with the client devices 104. For example, as shown in FIG. 1, the presence service 110 can include a proxy service 120 configured to send presence and messaging information through a firewall 108 associated with the client device B 104b. Information needed to support the proxy service 120 can be maintained in the general data store 116. It will be understood that like the presence 110 and messaging 112 services, the additional services, such as the account service 118 and proxy service 120 described above, can be distributed across one or more servers 102 or client devices 104 interconnected via the network 106.

The system 100 further includes means for storing integrated presence and messaging information, such as a tuple data store 114, operatively coupled to the presence 110 and messaging 112 services, configured to store presence and messaging information exchanged between the server 102 and the client devices 104. The services 110, 112 may use one or more data stores, which may include files, e.g., stored in memory or persistent storage, databases or a database management system (DBMS), and the like, to store the presence and messaging information. The tuple data store 114 can be separate, centralized data store, as shown in FIG. 1, or can be integrated into the server 102 and/or the client devices 104 to provide a distributed data store.

In an exemplary embodiment, the presence and messaging information is stored as tuples in their “on-the-wire” format, meaning that the information is stored in a data format compatible with the presence protocol(s) supporting the presence 110 and messaging 112 services. In this embodiment, the services 110, 112 need but one protocol to support all presence and messaging network communication. In other embodiments, the presence and messaging information may not be stored as tuple data suitable for transfer over the presence network, but instead may be translated into another format before storage. In either arrangement, the system 100 is configured to integrate presence and messaging information in local storage (e.g., in processor memory or persistent storage of the server 102 and/or the client devices 104), to structure the presence and messaging information into a common data format suitable for transmission over the network 106 via a presence protocol, or a combination of both of the foregoing to support the exchange of integrated presence and messaging information.

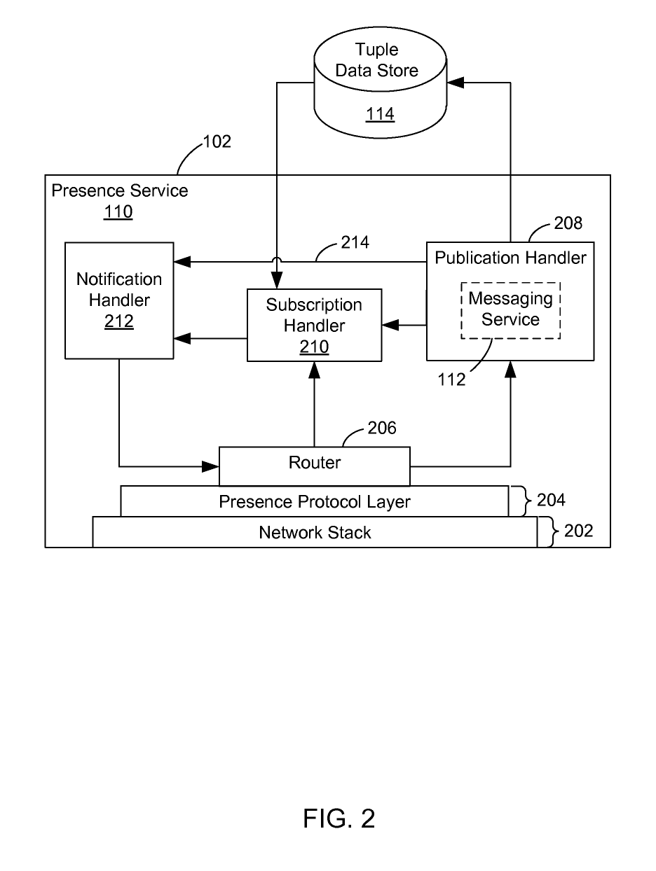

FIG. 2 illustrates a server device, such as the server 102 shown in FIG. 1, including a presence service for exchanging messages, according to an exemplary embodiment. In the exemplary embodiment, the server 102 is shown to include (or host) the presence service 110, providing a centralized presence/messaging service arrangement, although other arrangements, such as the peer-to-peer arrangement described above, are within the scope of the subject matter described here. The presence service 110 can be a general pub-sub service with support for presence information in addition to general pub-sub capabilities.

The server 102 includes a network protocol stack component 202 having a presence protocol layer 204 for communicating with the client devices 104. The network stack 202 can include both networking hardware (e.g., a network interface card, or NIC, such as an ETHERNET® adapter) and a transport stack (e.g., a TCP/IP stack) subsystem. The presence protocol layer 204 can be any protocol providing the functionality of publish, subscribe, and notify commands, as described in RFC 2779.

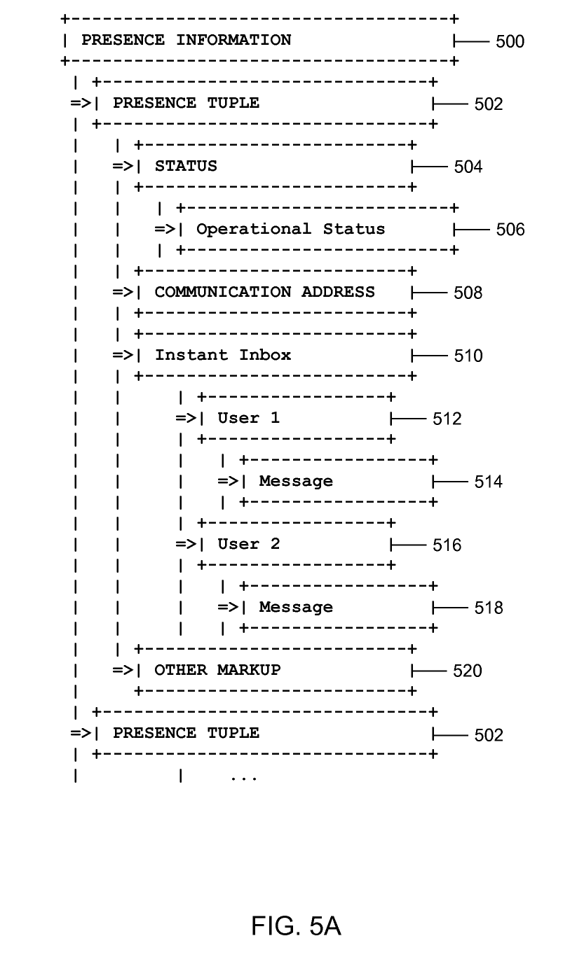

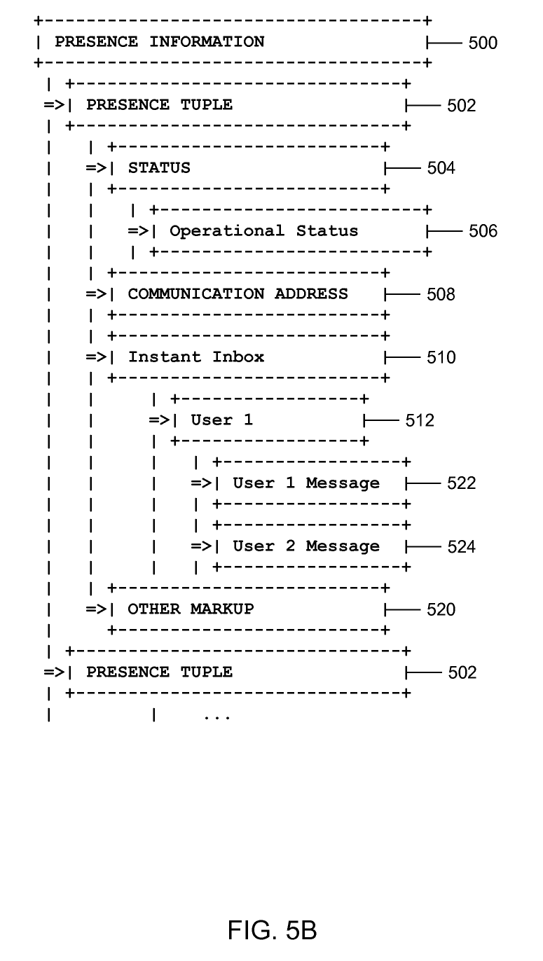

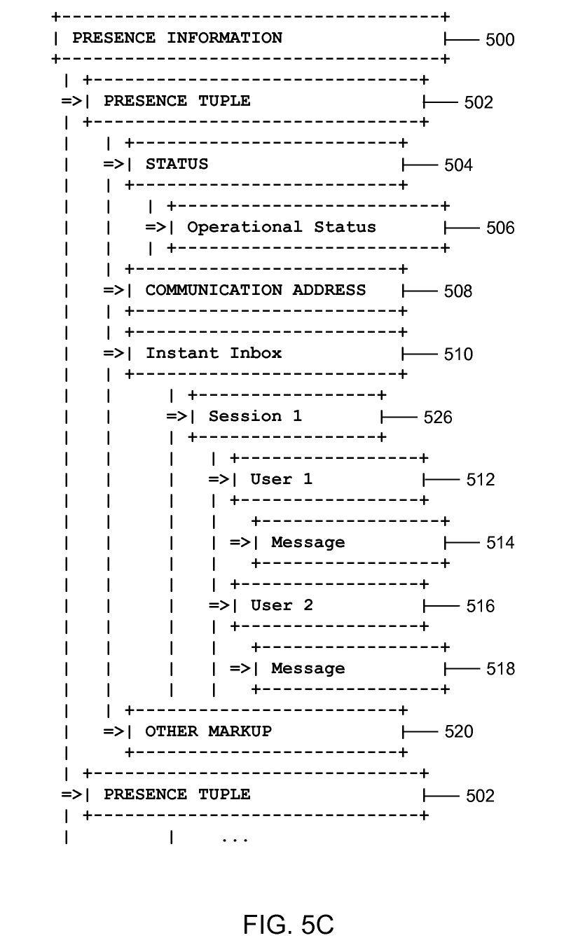

The presence service 110 includes means for receiving at least one of a presence status and a message sent from a first client of the presence service as integrated presence and messaging information conforming to a transmission format, such as a publication handler component 208, operatively coupled to the tuple data store 114 for storing integrated presence and messaging information. The publication handler component 208 is configured to receive at least one of a presence status and a message sent from a first client of the presence service, such as the cell phone 104a (or client device A), via a publish command. The publish command is capable of sending the presence status and message as integrated presence and messaging information conforming to a transmission format providing a status element for carrying the presence status and an inbox element for carrying the message. Several exemplary transmission formats are described below in conjunction with FIGS. 5A-5C and in the illustrative examples of protocol messages provided near the end of this document. The publication handler component 208 is configured to associate the information included in the publish command with one or more tuples stored in the tuple data store 114 and update the stored tuple information, accordingly.

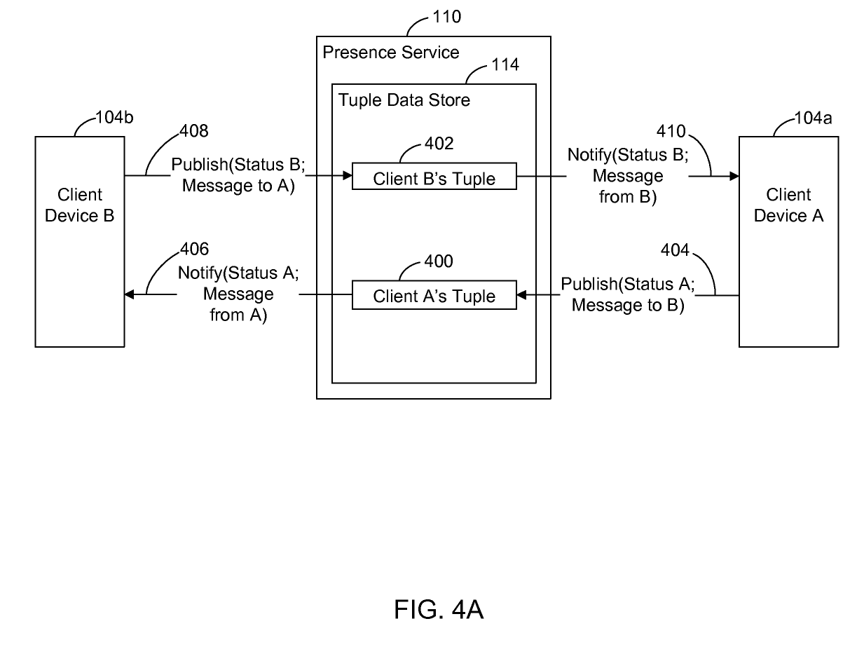

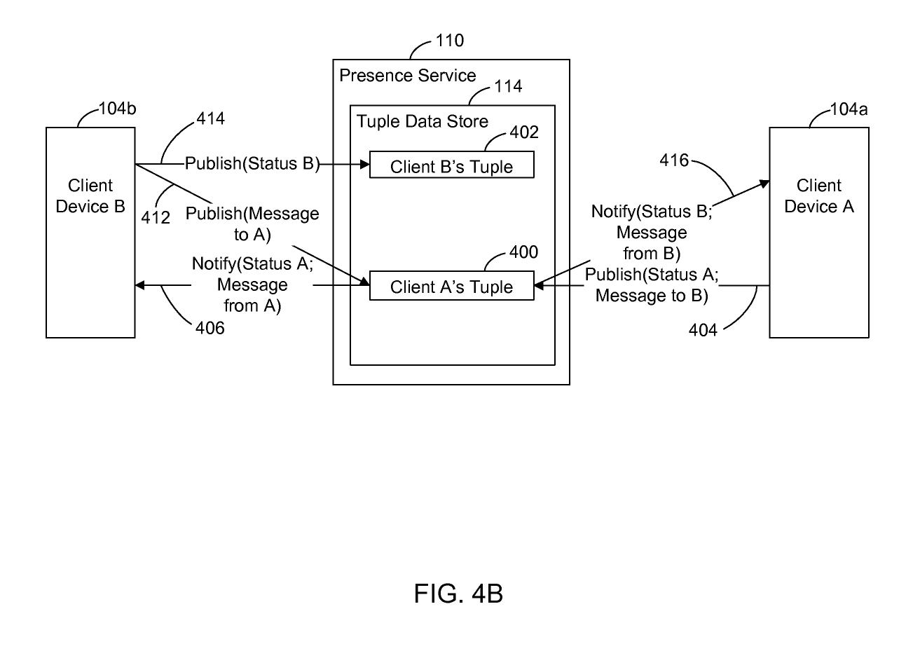

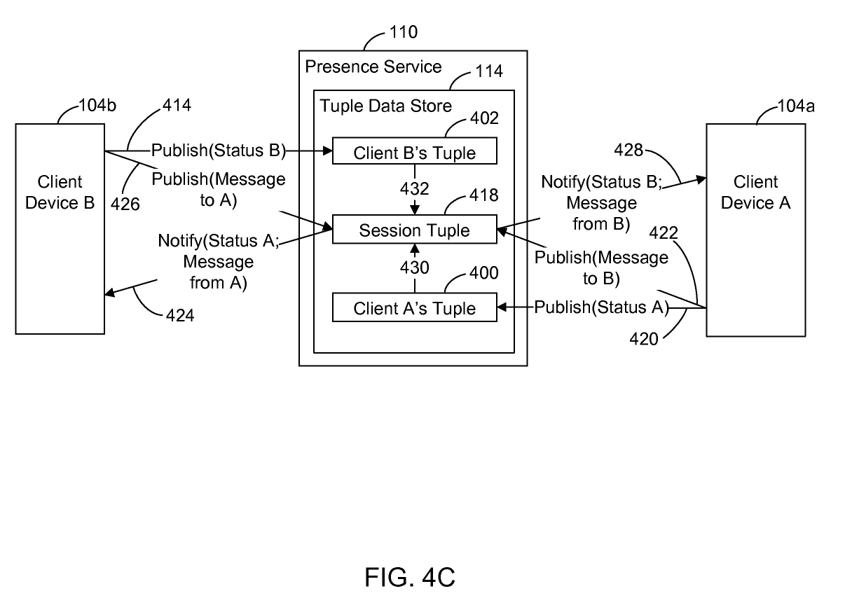

According to an exemplary embodiment, the presence service 110 can include a subscription handler component 210 operatively coupled to the publication handler component 208 and to the tuple data store 114. The subscription handler component 210 is configured to subscribe the first 104a and second 104b clients to respective message elements of at least one tuple including integrated presence and messaging information. As will be described in greater detail below in conjunction with FIGS. 4A-4C, the respective message elements to which subscriptions are maintained can be included in respective tuples owned by the first 104a and second 104b clients, a single tuple owned by one the first 104a and second 104b clients, or a shared tuple associated with a messaging session, and thus not “owned” by either the first 104a or second 104b client devices. In an exemplary embodiment, the subscription handler component 210 is configured to maintain subscription lists (such as a roster list) as tuples in the tuple data store 114. The subscription handler component 210 can interact with account service 118 to restrict subscription access to all or portions of particular tuples. The subscription handler component 210 can also be configured to determine when notifications are to be transmitted to the client devices 104, as detected through events generated by the publication handler component 208 or by the tuple data store 114.

The presence service 110 also includes means for sending a notification including at least one of the presence status and at least a portion of the message to a second client of the presence service in conformance with the transmission format, such as a notification handler component 212, operatively coupled to the publication hander component 208 and the tuple data store 114. The notification handler component 212 is configured to send a notification including at least one of the presence status and at least a portion of the message to a second client of the presence service, such as the PC 104b (or client device B), via a notify command. The notify command is also capable of sending the notification in conformance with the transmission format briefly mentioned above and described in greater detail below. On instruction from the publication 208 and/or subscription 210 handler components, the notification handler component 212 is configured to format the presence and messaging information for inclusion in the notify command. The notification handler component 212 is further configured to track the delivery status of notifications that have been send and can support resending notifications to assure delivery to the presence and messaging clients 104.

The presence service 110 further includes a router component 206 operatively coupled to the publication 208 and notification 212 handler components, the presence protocol layer 204 of the network protocol stack component 202, optionally to the subscription handler component 210. The router component 206 is configured to route the publish and notify commands between the publication 208 and notification 212 handler components and the first 104a and second 104b presence service clients. The router component 206 interfaces with the presence protocol layer 204 to send notify commands and to receive publish and subscribe commands to and from the client devices 104. For example, subscribe and get commands received from the client devices 104 can be passed to the subscription handler component 210, while publish commands that are received from the client devices 104 can be passed to the publication handler component 208 for processing.

The router component 206 can pass the received presence data packets unchanged to the publication 208 and subscription 210 handler components, but typically reformats the received data packets into structures or objects that are more suitable for processing both those components. The router component 206 can also format the presence and messaging information received from the notification handler component 212 for inclusion in a notify command into a data packet compatible with the presence protocol supporting the presence service 110.

Presence service 110 is integrated with messaging service 112. Integration can be through the use of a common protocol and/or a common data model—a preferred embodiment uses both levels of integration. In an exemplary embodiment, the messaging service 112 is incorporated as a subcomponent of the publication handler component 208. In other embodiments, the messaging service 112 could be integrated with other components of the presence service 110 or could be a stand-alone component that functions in conjunction with the other presence service components.

In the exemplary embodiment, the messaging service 112 is configured to parse a message portion of a tuple (described below in conjunction with FIGS. 5A-5C) to extract a message received from a client device, e.g., from cell phone 104a. The messaging service 112 is further configured to send the extracted message immediately to a specified recipient (e.g., to PC 104b), if any, via a directed notify command by forwarding the message and tuple address for the recipient directly to the notification handler component 212 via the link 214. Alternatively, the messaging service 112 can pass the message data to the subscription handler component 210, which is configured to determine the current subscribers to the tuple(s) associated with the message and to forward the message and tuple address(es) for the subscriber(s) to the notification handler component 212 for delivery of the message to the subscriber(s).

Consistent with the meaning of a pub-sub/presence service in the context of this document, the messaging service 112 need not save messages for intended recipients if they are not available when the message is received. In other embodiments, however, the messaging service 112 may be configured to store messages for unavailable recipient, for example, saving a most recently received message.

According to an exemplary embodiment, the presence service 110 can be configured to create and maintain a first tuple in the data store for the first client when a first message destined for the second client is generated by the first client. The first tuple is addressable via a publish command. For example, referring to FIG. 4A, a first tuple 400 for client device A 104a can be created in the tuple data store 114 by the presence service 110 when client device A 104a generates a first message for client device B 104b via a publish command 404. In the exemplary embodiment, the presence service can also create and maintain a second tuple in the data store for the second client when a first message destined for the first client is generated by the second client. The second tuple is also addressable via a publish command. Referring again to FIG. 4A, a second tuple 402 for client device B 104b can be created in the tuple data store 114 by the presence service 110 when client device B 104b generates a second message for client device A 104a via a publish command 408.

Alternatively, the second tuple 402 could be created by the presence service 110 at the same time the first tuple 400 is created, i.e., when a first message for client device B 104b is received from client device A 104a via the publish command 404. The second tuple 402 would be created in anticipation of client device B 104b responding to the message received from client device A 104a. Such an arrangement does present added security concerns, as tuples would be created in the tuple data store 114 for clients based (albeit indirectly) on the actions of other clients.

Continuing with the exemplary embodiment, each of the created tuples has a structure corresponding to the transmission format. The presence service 110 is further configured to associate portions of the presence and messaging information exchanged between client devices A 104a and B 104b with the first and second tuples. The first tuple can include a first message element associated with the second client for carrying (or storing) the message sent from the first client to the second client. In addition, a corresponding inbox element of the second tuple can include a second message element associated with the first client for carrying (or storing) a second message sent from the second client to the first client.

For example, FIG. 5A illustrates a data model for exchanging and/or storing integrated presence and messaging information 500 that is suitable for the tuple arrangement shown in FIG. 4A. The tuple structure 502 shown in FIG. 5A is compliant with the tuple structure described in RFC 2778, and includes an extension depicted as an “Instant Inbox” sub-tuple 510. “Instant inboxes” are well-known to persons familiar IM systems. It will be understood that other sub-tuples could be added to the tuple structure shown in FIG. 5A to support other message types, such as SMS and MMS messages. The tuple structure shown in FIG. 5A is an exemplary tuple that is compatible with both the first 400 and second 402 tuples discussed in conjunction with FIG. 4A above. Each tuple owner may update the “Instant Inbox” of his/her/its tuple typically by publishing partial tuples to the presence service 110 including only the message element of an instant inbox user/messaging partner sub-tuple, e.g., message element 514 of the instant inbox element 510 corresponding to User 1. Thus, if the tuple 502 shown in FIG. 5A corresponds to the first tuple 400 for client device A 104a shown in FIG. 4A, then the user sub-tuple 512 could be associated with client device B 104b, and messages for client device B 104b could be published by client device A 104a to the message element 514.

In an exemplary embodiment, the tuple structure 502 can include user/messaging partner sub-tuples allocated for each “friend” (e.g., clients included in a roster list associated with the tuple owner). For example, the tuple 502 is shown to include a second user/messaging partner sub-tuple 516 for a second user (“User 2”) having a corresponding message element 518. Directed publishes, i.e., publish commands resulting in notify commands without involving a subscription, may be used to send a message to a specific friend or friends not included on a roster list. In addition, the presence service 110 can be configured to send messages with no specified recipients to all subscribers, subject to any access control restrictions, e.g., as managed by the account service 118.

In some embodiments, the presence service 110 can be configured to allocate a sub-tuple for the principal, while in other embodiments, the presence service 110 may relay messages to the principal without adding additional information to the principal's existing tuple. The presence service 110 can be configured to add user/messaging partner sub-tuples to the principal's tuple on demand, and such tuples can exist as long as a messaging session continues (if sessions are supported) or until some specified time period after all recipients have been notified has been reached. Sessions are described in detail in another exemplary embodiment described below.

In a related embodiment, the subscription handler component 210 is configured to subscribe the second client to the first message element of the first tuple and subscribe the first client to the second message element of the second tuple. For example, referring again to the arrangement shown in FIG. 4A, client device B 104b can be subscribed to the first tuple 400 associated with client device A 104a, such that when client device A 104a publishes a message to its tuple 400 via the publish command 404, the subscription handler component 210 can instruct the notification handler component 212 to send a notify command 406 to client device B 104b including the published message. Similarly, client device A 104a can be subscribed to the second tuple 402 associated with client device B 104b, such that when client device B 104b publishes a second message (e.g., a response to the first message) to its tuple 402 via the publish command 408, the subscription handler component 210 can instruct the notification handler component 212 to send a notify command 410 to client device A 104a including the published message.

The tuple arrangement depicted in FIG. 4A allows principals to publish only to his/her/its own tuples. That is, to send a message to another client, a principal requests his/her/its client to publish a tuple, or partial tuple, including a message to the principal's tuple. The publish command may be directed, where one or more recipients are specified, and/or undirected, where at least a portion of subscribers to the tuple may be sent a notification containing the message sub-tuple.

Note that in the arrangement shown in FIG. 4A, that a principal can request his/her/its client to publish a tuple, or partial tuple, including a status to the principal's own tuple as occurs in conventional presence systems, e.g., via the publish commands 404, 408 shown in the figure. The status can be published to a status element 504 of the exemplary tuple 502 shown in FIG. 5A. The status element 504 can include sub-tuples including additional status information, such as the operational status element 506 shown in the figure. The tuple 502 can include an additional sub-tuple/element for adding other markup 520, allowing the tuple 502 be extensible as described in RFC 2778.

In another exemplary embodiment, the presence service 110 can be configured to create and maintain a tuple in the data store for one of the first and second clients, e.g., the first client. Although created and maintained for only one of the clients, the single tuple is addressable via publish commands by each client. That is, each client (indeed, any number of clients) can publish messages to the tuple to exchange messaging information with another. For example, referring to FIG. 4B, the tuple 400 for client device A 104a can be created in the tuple data store 114 by the presence service 110 when client device A 104a generates a first message for client device B 104b via the publish command 404. Once the tuple 400 has been created, client device B 104b can generate a second message (e.g., a response) for client device A 104a and publish the second message to the tuple 400 via a publish command 412.

FIG. 4B depicts an embodiment in which a communication session takes place by all participants (two or more) publishing to a single tuple. Typically, this tuple would be owned by the initiator of the session, but other arrangements are easily envisioned. For example, assume that several principals engage in a messaging session supported by a peer-to-peer presence service 110, where the tuples of the various principals are not hosted on a same server 102. Assume also, that one of the services 110 in the peer-to-peer arrangement is hosted on a server system with performance characteristics detectably better than the other participants. The services 110 may be setup to allow a session to be hosted by the fastest service provider. The session may be configured to move if the hosting service goes down or if its performance degrades. One can easily see that there is a continuum of solutions between the extremes of the embodiment shown in FIG. 4A, where each messaging participant publishes to its own tuple, and the embodiment shown in FIG. 4B where all messaging participants publish through a common tuple.

Continuing with the exemplary embodiment, the one tuple created and maintained by the presence service 110, e.g., tuple 400 for client device A 104a, has a structure corresponding to the transmission format. The presence service 110 is again configured to associate portions of the presence and messaging information exchanged between client devices A 104a and B 104b with the single tuple. A corresponding inbox element of the tuple can include a first message element associated with the client for which the tuple is maintained, and a second message element associated with the other client. That is, the tuple can be maintained by the presence service for the first client, such that the first message element is associated with the second client and is configured to carry (or store) the message sent from the first client to the second client. In addition, the second message element can be associated with the first client and is configured to carry (or store) a second message (e.g., a response) sent from the second client to the first client.

For example, FIG. 5B illustrates a data model for exchanging and/or storing integrated presence and messaging information 500 that is suitable for the tuple arrangement shown in FIG. 4B. The tuple structure 502 shown in FIG. 5B is again compliant with the tuple structure described in RFC 2778, and includes an extension depicted as an “Instant Inbox” sub-tuple 510. The tuple structure shown in FIG. 5B is an exemplary tuple that is compatible with the tuple 400 discussed in conjunction with FIG. 4B above. Each client device 104 may update the “Instant Inbox” of the common tuple 400 typically by publishing partial tuples to the presence service 110 including only the message element of an instant inbox user/messaging partner sub-tuple, e.g., message elements 522 and 524 of the instant inbox element 510 corresponding to User 1.

Thus, if the tuple 502 shown in FIG. 5B corresponds to the tuple 400 for client device A 104a shown in FIG. 4B, then the message element 522 could be associated with client device A 104a, and messages for client device A 104a could be published by client device B 104b to the message element 522 (e.g., “User 1 Message”). Similarly, the message element 524 could be associated with client device B 104b, and messages for client device B 104b could be published by client device A 104a to the message element 524. Additional message elements could be added to the instant inbox sub-tuple 510 to allow other users to participate in the messaging session. Embodiments in which the presence service 110 pre-allocates message tuples/elements and/or allocates message tuples/elements on demand are possible as described above in conjunction with FIG. 5A.

In a related embodiment, the subscription handler component 210 is configured to subscribe the second client to the first message element of the tuple and to subscribe the first client to the second message element of the tuple. For example, referring again to the arrangements shown in FIGS. 4B and 5B, client device B 104b can be subscribed to the message element 524 of the tuple 400, 502 associated with client device A 104a, such that when client device A 104a publishes a message to its tuple 400 via the publish command 404, the subscription handler component 210 can instruct the notification handler component 212 to send a notify command 406 to client device B 104b including the published message. Similarly, client device A 104a can be subscribed to the message element 522 of the tuple 400, 502 associated with client device A 104a, such that when client device B 104b publishes a second message (e.g., a response to the first message) to the tuple 400 via the publish command 412, the subscription handler component 210 can instruct the notification handler component 212 to send a notify command 416 to client device A 104a including the published message.

In yet another related embodiment, the presence service 110 can be configured to restrict access of the client for which the tuple is not maintained to the second message element of the tuple used for carrying (or storing) messages published to the client for which the tuple is maintained. The presence service 110 can utilize the account service 118 to manage access control to the tuple. Thus, in the example described in conjunction with FIGS. 4B and 5B above, client device B's 104b access to the tuple 400 can be restricted to publishing partial tuples, including messages for client device B 104b, to message element 522 of the tuple 400 owned by client device A 104a.

Note once again in the arrangement shown in FIG. 4B, that a principal can request his/her/its client to publish a tuple, or partial tuple, including a status to the principal's own tuple as occurs in conventional presence systems, e.g., via the publish commands 404, 414 shown in the figure. The status can be published to a status element 504 of the exemplary tuple 502 shown in FIG. 5B. Thus, although messaging information is published to a common tuple 400 in the arrangement, status is still published to a principal's own presence tuple. In other embodiments, the status element 504 can be further extended to support publishing the status of each contributor to a messaging session (not shown). Again, the other markup sub-tuple 520 is shown in FIG. 5B to indicate that the tuple 502 is extensible.

Another exemplary embodiment allows the presence server 110 to create and maintain a session tuple in the data store for both the first and second clients when a first message for exchange between the first and second clients is generated by one of the presence service clients. The session tuple is addressable via publish commands by each client. That is, each client (indeed, any number of clients) can publish messages to the session tuple to exchange messaging information with another. For example, referring to FIG. 4C, the session tuple 418 can be created in the tuple data store 114 by the presence service 110 when either client device A 104a or client device B 104b generates a first message for the other client device, e.g., via the publish command 422 by client device A 104b. Once the session tuple 418 has been created, client device B 104b can generate a second message (e.g., a response) for client device A 104a and publish the second message to the session tuple 418 via a publish command 426.

FIG. 4C depicts an embodiment where a session tuple, shared by all messaging participants, is created for the duration of the communication session. From a security standpoint, this arrangement can be simpler to implement and manage than the embodiment shown FIG. 4B, in which the shared tuple was owned by one of the messaging participants. Where the shared tuple is hosted may be determined by any number of characteristics, as described above in conjunction with the arrangement shown in FIG. 4B. Only a few exemplary characteristics have been discussed for use in the determination of where a shared tuple should be stored or how many shared tuples should be used. Sharing a tuple has the advantage that the tuple may be used for more than message exchange. It may also provide storage for a common workspace allowing participants to jointly work on a document, a drawing, or other form of shared activity.

Continuing with the exemplary embodiment, the session tuple 418 created and maintained by the presence service 110 has a structure corresponding to the transmission format. The presence service 110 is configured to associate portions of the presence and messaging information exchanged between client devices A 104a and B 104b with the session tuple 418. A corresponding inbox element of the tuple can include a session element having a session identifier for identifying a messaging session between the first and second clients, a first message element associated with one of the presence service clients for carrying the message, and a second message element associated with the other of the presence service clients for carrying a second message.

For example, FIG. 5C depicts a tuple structure similar to that shown in FIG. 5A, but including a separate session sub-tuple 526 within the instant inbox sub-tuple 510 to maintain one or more messaging sessions. The session sub-tuple may be used in a similar manner to shared tuples, such as the user tuple 512 depicted in FIG. 5B. Shared tuples “owned” jointly by the messaging participants are as described in the architecture depicted in FIG. 4B, and may be similar to the instant inbox portions of each of FIGS. 5A-5C. Each messaging participant's tuple may have reference to each jointly “owned” message tuple the principal is using for communications.

The data model depicted in FIG. 5C for exchanging and/or storing integrated presence and messaging information 500 is suitable for the tuple arrangement shown in FIG. 4C. The tuple structure 502 shown in FIG. 5C is compliant with the tuple structure described in RFC 2778, and includes an extension depicted as an “Instant Inbox” sub-tuple 510. The tuple structure shown in FIG. 5C is an exemplary tuple that is compatible with the session tuple 418 discussed in conjunction with FIG. 4C above. Each client device 104 may update the “Instant Inbox” of the session tuple 418 typically by publishing partial tuples to the presence service 110 including only the message element of an instant inbox user/messaging partner sub-tuple, e.g., message elements 514 and 518 of the instant inbox element 510 of the session tuple.

Thus, if the user sub-tuple 512 is associated with client device B 104b, messages for client device B 104b could be published by client device A 104a to the message element 514. Similarly, if the user sub-tuple 516 is associated with client device A 104a, messages for client device a 104a could be published by client device B 104b to the message element 518. Additional user sub-tuples could be added to the instant inbox sub-tuple 510 to allow other users to participate in the messaging session. Embodiments in which the presence service 110 pre-allocates message tuples/elements and/or allocates message tuples/elements on demand are possible as described above in conjunction with FIG. 5A.

In a related embodiment, the subscription handler component 210 is configured to subscribe the first and second clients to respective message elements of the session tuple. For example, referring again to the arrangements shown in FIGS. 4C and 5C, client device B 104b can be subscribed to the message element 514 of the tuple 418, 502 associated with client device A 104a, such that when client device A 104a publishes a message to the session tuple 418 via the publish command 422, the subscription handler component 210 can instruct the notification handler component 212 to send a notify command 424 to client device B 104b including the published message. Similarly, client device A 104a can be subscribed to the message element 518 of the tuple 418, 502 associated with client device B 104b, such that when client device B 104b publishes a second message (e.g., a response to the first message) to the tuple 418 via the publish command 426, the subscription handler component 210 can instruct the notification handler component 212 to send a notify command 428 to client device A 104a including the published message.

The presence server 110 is further configured to assign the session identifier to the session tuple 418 allowing messages exchanged between the first and second clients to be linked via the session identifier. Examples of linking messages via a session identifier are provided in the illustrative examples of protocol messages provided near the end of this document.

In the arrangement shown in FIG. 4C, a principal can request his/her/its client to publish a tuple, or partial tuple, including a status to the principal's own tuple as occurs in conventional presence systems, e.g., via the publish commands 420, 414 shown in the figure. The status can be published to a status element 504 of the exemplary tuple 502 shown in FIG. 5C. Thus, although messaging information is published to the shared session tuple 418 in the arrangement, status is still published to a principal's own presence tuple. In other embodiments, the status element 504 can be further extended to support publishing the status of each contributor to a messaging session tuple (not shown). Alternatively, the status for the various clients can be transferred from the client tuples 400, 402 to the session tuple 418, as shown by the links 430 and 432. Again, the other markup sub-tuple 520 is shown in FIG. 5C to indicate that the tuple 502 is extensible.

### Presence/Messaging Client

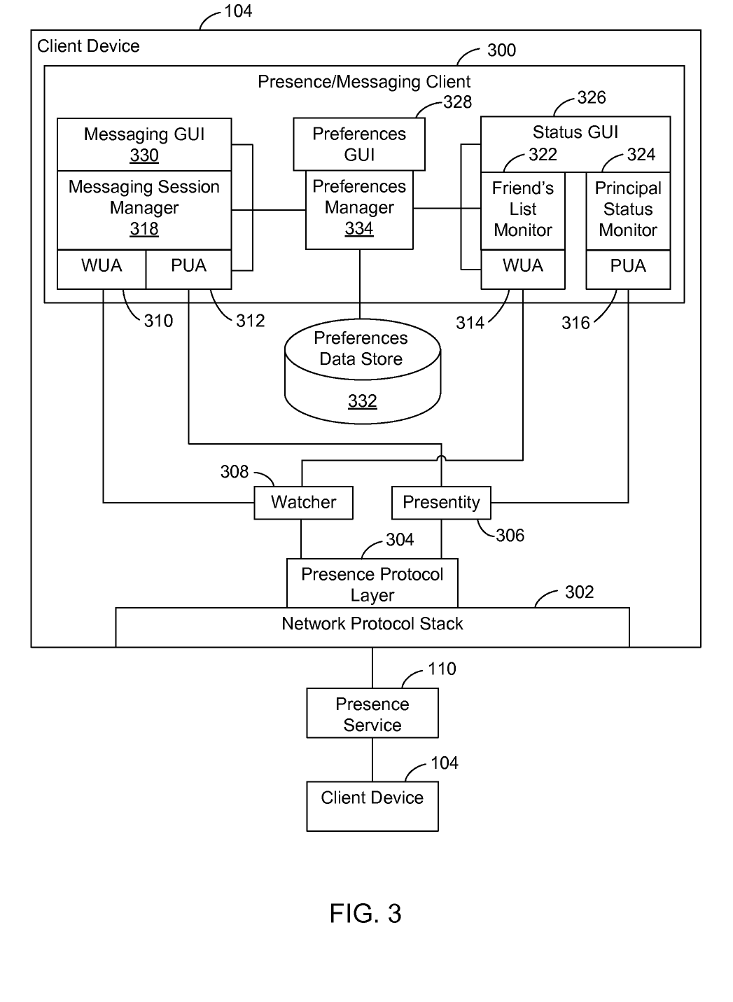

FIG. 3 illustrates a client device for exchanging messages using a presence service, according to an exemplary embodiment. The detailed view of the client device depicted in FIG. 3 can correspond to any of the cell phone 104a, the PC 104b, and the camera 104c depicted in FIG. 1. The client device 104 includes a network protocol stack component 302 having a presence protocol layer 304 configured to communicate with the presence 110 and messaging 112 services. Although the functions of the stack component 302 and presence protocol layer 304 are substantially the same as those like-named components of the server 102 depicted in FIG. 2, the server 102 and client device 104 could have different protocol stack components that employ different presence protocol layers (albeit, presence protocol layers that conform to RFC 2779).

The client device 104 further includes a presentity component 306, operatively coupled to the at least one GUI component (described in greater detail below) and the network protocol stack component 302 with its presence protocol layer 304. The presentity component 306 is configured to send at least one of a presence status and a message to the presence service 110 via a publish command. As described above in conjunction with the server 102 depicted in FIG. 2, the publish command is capable of sending the presence status and message as integrated presence and messaging information conforming to a transmission format providing a status element for carrying the presence status and an inbox element for carrying the message. Several exemplary transmission formats have been described above in conjunction with FIGS. 5A-5C and are included in the illustrative examples of protocol messages provided near the end of this document.

As described in RFC 2778, the presentity component 306 is a “presence entity” that communicates with a presence service, such as presence service 110, on behalf of publishing clients, such as the presence/messaging client 300 shown in FIG. 3. As described above, the presence/messaging client may be a principal (e.g., a person) or may be acting on behalf of a principal (e.g., an application executing for a person). The presentity component 306 may serve one or more publishing clients, and can communicate with a client via a presentity user agent (PUA) component 312, 316, described in greater detail below. The presentity component 306 serves the role of translator between the commands of the presence protocol layer 304 and the data format understood by the PUA component 312, 316 (which is typically proprietary). As described above, full and partial tuples may be published to publication handler component 208 of the server 102 by the presentity component 306 in the preferred implementation. Thus, if a tuple owner's status has not changed, yet the tuple owner sends a message to recipient via the presence 110 and messaging 112 services, the owner's status does not have to be published to the owner's tuple along with the message.

The client device 104 further includes a watcher component 308, operatively coupled to the at least one GUI component and the network protocol stack component 302. The watcher component is configured to receive a notification including at least one of a presence status and a message via a notify command. As described above, the notify command is capable of sending the notification in conformance with the transmission format, such as the exemplary data formats shown in FIGS. 5A-5C.

In accordance with RFC 2778, the watcher component 308 is also a “presence entity” that communicates with the presence server 110 on behalf of one or more clients. Like the presentity component 306, the watcher component 308 interacts with a client through an agent, referred to as a watcher user agent (WUA) component 310, 314, described in more detail below. The watcher component 308 translates information included in the commands of the presence protocol layer 304 into a data format used by the WUA 310, 314 (which is typically proprietary). The watcher component 308 serves clients that are watching or subscribed to presence information (or tuples) by sending, for example, commands including subscription requests to the subscription handler component 210 of server 102 on behalf of a WUA component 310, 314, and by routing notifications received from the notification handler component 212 corresponding to those subscription requests to the intended WUA components 310, 314. The watcher component 308 can subscribe to whole or partial tuples (e.g., sub-tuples).

The client device 104 further includes at least one graphical user interface (GUI) component configured to gather and present at least one of presence status information and messaging information. For example, the client device 104 depicted in FIG. 3 is shown to include a messaging GUI component 330 configured to display messages received through the client's 300 WUA component 310 and to provide an interface allowing a principal to enter a message to send to another user via the client's 300 PUA component 312.

The client device 104 can further include a messaging session manager component 318, operatively coupled to the at least one GUI component and at least one of the presentity component and the watcher component. For example, the messaging session manager component 318 can be coupled to messaging GUI component 330 and watcher 308 and presentity 306 components via WUA component 310 and PUA component 312, respectively, to assign a session identifier to messages associated with a messaging session. The session identifier allows the messages of a messaging session (e.g., a chat session) processed by the presence/messaging client 300 to be linked to one another via the session identifier. Some message services, such as IM, support message sessions enabling messages to be associated with one another via a session identifier. Other messaging systems, such as SIP's SIMPLE are sessionless. The session identifier can be carried (or stored) in at least one tuple element associated with the messaging session participant, such as the session element included in the session sub-tuple 526 shown in FIG. 5C.

As mentioned briefly above, the client device 104 can include at least one user agent component configured to translate presence status and messaging information exchanged between the at least one GUI component and at least one of the presentity component 306 and the watcher component 308. For example, the client device 104 depicted in FIG. 3 is shown to include WUA components 310, 314 integrated into the presence/messaging client 300, although the WUA components 310, 314 could be arranged external to the presence/messaging client 300. Similar to the watcher component 308, the WUA components 310, 314 translates and routes presence and messaging information, but does so between a data format known to the watcher component 308 and a data format known to the presence/messaging client 300. When the presence/messaging client 300 and watcher component 308 use the same or compatible data format, the WUA components 310, 314 mainly function as a message router. For example, the WUA components 310, 314 can send subscribe requests to the watcher component 308 and can pass notifications received from the watcher component to the presence/messaging client 300 for processing.

The client device 104 depicted in FIG. 3 is also shown to include PUA components 312, 316 integrated into the presence/messaging client 300, although again the PUA components 312, 316 could be arranged external to the presence/messaging client 300. The PUA components 312, 316 operate similar to the WUA components 310, 314, except that the PUA components 312, 316 translates information exchanged between the presence/messaging client 300 and the presentity component 306. The arrangement depicted in FIG. 3 shows separate PUA and WUA components serving separate presence and messaging functions of the presence/messaging client 300. It will be understood that PUA components 312, 316 can be integrated into a single PUA component, WUA components 310, 314 can be integrated into a single WUA component, or all PUA and WUA components can be integrated into a single user agent, each serving both the presence and messaging functions of the presence/messaging client 300.

In addition to the messaging GUI component 330 described above, the client device 104 can also include a status GUI component 326. The status GUI component 326 can display presence information associated with active subscriptions of various other principals and receives (and usually displays) the presence information of the principal associated with the presence/messaging client 300. In a related embodiment, the client device 104 can include a principal status monitor component 324, operatively coupled to the status GUI component 326 and the presentity component 306 via the PUA component 316. The principal status monitor component 324 is configured to monitor activity on the client device 104 and to automatically update the presence status of a principal associated with the client device based on the monitored activity.

For example, the principal status monitor component 324 can provide status information, and optionally other presence information, to the PUA component 316 for publication to the principal's tuple. The principal status monitor component 324 may function passively, requiring the principal to provide updates to his/her/its presence information, e.g., via the status GUI component 326, or may be active in determining the principal's status and other presence information for automatic publication to the presence service 110. In some embodiments, the principal status monitor component 324 may operated both passively and actively in publishing the principal's status.

In yet another related embodiment, the client device 104 can include a roster list monitor component 322, operatively coupled to the status GUI component 326 and the watcher component 308. The roster list monitor component 322 is configured to request subscriptions to, and monitor the presence status information of, each of the presence service clients associated with entries in a roster list. For example, the roster list monitor component 322 is configured to subscribe to the presence information of each of the entries in the principal's roster list. When the roster list monitor component 322 receives notifications associated with a subscription via the watcher 308 and WUA 310 components, the monitor component 322 can instruct the status GUI component 326 to display at least a portion of the updated status information that is received. This allows a principal to see who may be available for receiving a message.

According to an exemplary embodiment, the client device 104 can include preferences manager component 334 configured to at least one of retrieve, store, and validate settings and options associated with a principal associated with the client device. The client device 104 can include a preferences data store 332, coupled to the preferences manager component 334, for storing the principal's preferences and settings. Although a local data store is shown in the diagram, other embodiments may allow the preferences and settings to be published and retrieved (e.g., via fetch or notify commands) from the presence service. The client device 104 can also includes a preferences GUI component 328, coupled to the preferences manager component 330, configured to present the preferences and settings to the principal, allowing the principal to view and/or change the preferences and settings.

The arrangements described in conjunction with FIGS. 1-3 advantageously allow the following components of conventional presence-aware messaging systems to eliminated:
Separate Messaging Protocol Layer
Separate service for messaging
Separate security components to coordinate authentication, authorization and encryption
Client messaging agent (PUA and WUA components can fulfill function)
Additional message proxy and/or relays for piercing firewalls
Separate setup and configuration systems
Separate management and monitoring systems
Synchronization between the ability to exchange messages and receive status is coordinated in one service rather across two services that use different protocols. Allows for the removal a third intercommunication mechanism, which is typically developed and used in conventional presence-aware messaging systems.

A complementary client architecture for utilizing a presence service to facilitate access to services over a network is described in related U.S. patent application Ser. No. 11/096,764, titled “System and Method for Utilizing A Presence Service to Facilitate Access to a Service or Application Over A Network,” filed on Mar. 31, 2005, (Attorney Docket No. 1-309), assigned to the same assignee as this application, the entire disclosure of which has been incorporated here by reference.

In addition, the functionality of the presence/messaging client 300 described here could be combined with the generic browser client and associated techniques capable of browsing network resources using an asynchronous communications protocol described in related U.S. patent application Ser. No. 11/160,612, titled “Method And Apparatus For Browsing Network Resources Using An Asynchronous Communications Protocol,” filed on Jun. 30, 2005, (Attorney Docket No. 1-328), assigned to the same assignee as this application, the entire disclosure of which has been incorporated here by reference.

### Presence/Messaging Methods

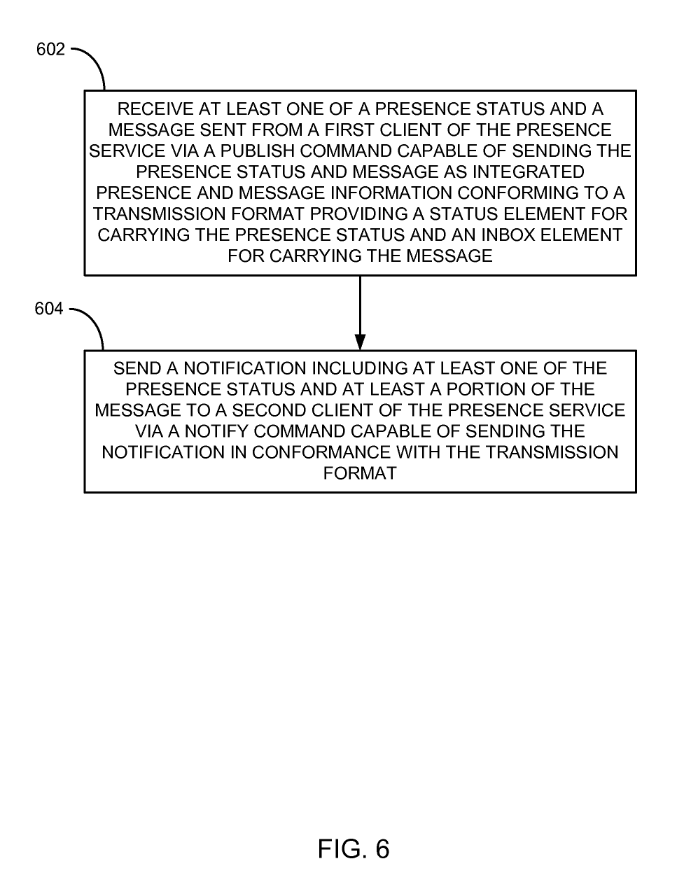

FIG. 6 is a flowchart illustrating a method for exchanging messages using a presence service, according to an exemplary embodiment. The method can be carried out using the exemplary system depicted in FIGS. 1 and 2, portions of which are referenced below for illustration purposes.

In block 602, at least one of a presence status and a message sent from a first client of the presence service is received via a publish command capable of sending the presence status and message as integrated presence and messaging information. The publish command conforms to a transmission format providing a status element for carrying the presence status and an inbox element for carrying the message.

For example, as described in conjunction with FIG. 2, the presence service 110 includes a publication handler component 208, operatively coupled to the tuple data store 114 for storing integrated presence and messaging information. The publication handler component 208 is configured to receive at least one of a presence status and a message sent from a first client of the presence service, such as the cell phone 104a (or client device A), via a publish command. The publish command is capable of sending the presence status and message as integrated presence and messaging information conforming to a transmission format providing a status element for carrying the presence status and an inbox element for carrying the message. Several exemplary transmission formats are described below in conjunction with FIGS. 5A-5C and in the illustrative examples of protocol messages provided near the end of this document. The publication handler component 208 is configured to associate the information included in the publish command with one or more tuples stored in the tuple data store 114 and update the stored tuple information, accordingly.

In block 604, a notification including at least one of the presence status and at least a portion of the message is sent to a second client of the presence service via a notify command capable of sending the notification in conformance with the transmission format.

For example, as described in conjunction with FIG. 2, the presence service 110 also includes a notification handler component 212, operatively coupled to the publication hander component 208 and the tuple data store 114, configured to send a notification including at least one of the presence status and at least a portion of the message to a second client of the presence service, such as the PC 104b (or client device B), via a notify command. The notify command is also capable of sending the notification in conformance with the transmission format briefly mentioned above and described in greater detail below. On instruction from the publication 208 and/or subscription 210 handler components, the notification handler component 212 is configured to format the presence and messaging information for inclusion in the notify command. The notification handler component 212 is further configured to track the delivery status of notifications that have been send and can support resending notifications to assure delivery to the presence and messaging clients 104.

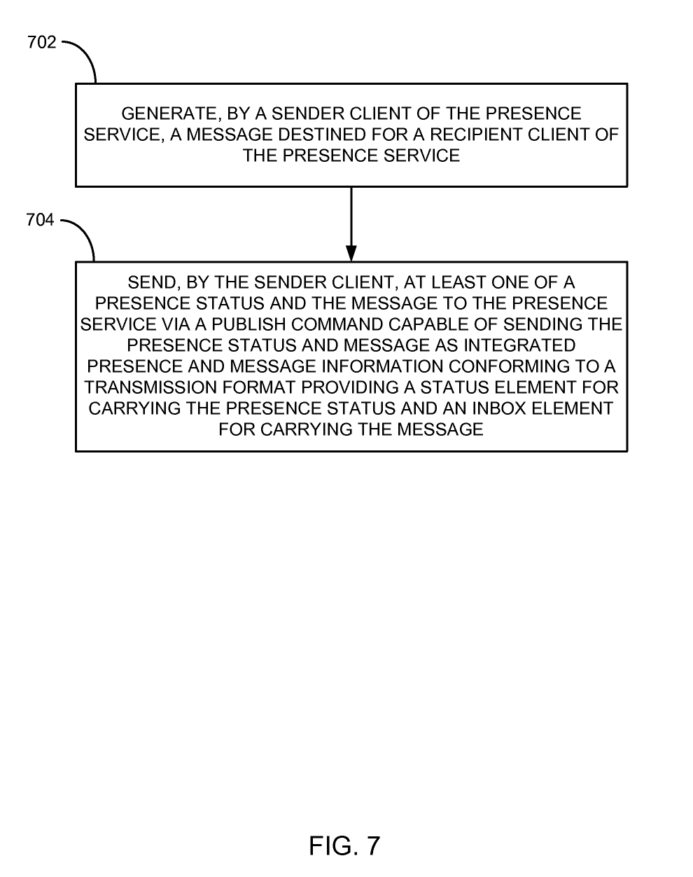

FIG. 7 is a flowchart illustrating a method for sending messages using a presence service, according to an exemplary embodiment. The method can be carried out using the exemplary system depicted in FIGS. 1 and 3, portions of which are referenced below for illustration purposes.

In block 702, a sender client of the presence service generates a message destined for a recipient client of the presence service. For example, the client device 104 depicted in FIG. 3 is shown to include a messaging GUI component 330 configured to provide an interface allowing a principal to generate a message to send to another user via the client's 300 PUA component 312. The PUA component 312 is configured to translate the message generated via the messaging GUI component 330 into a data format understood by the presentity component 306.

In block 704, the sender client sends at least one of a presence status and the message to the presence service via a publish command capable of sending the presence status and message as integrated presence and messaging information. The publish command conforms to a transmission format providing a status element for carrying the presence status and an inbox element for carrying the message.

For example, as described above in conjunction with FIG. 3, the client device 104 further includes a presentity component 306, operatively coupled to the at least one GUI component (described in greater detail below) and the network protocol stack component 302 with its presence protocol layer 304. The presentity component 306 is configured to send at least one of a presence status and a message to the presence service 110 via a publish command. As described above in conjunction with the server 102 depicted in FIG. 2, the publish command is capable of sending the presence status and message as integrated presence and messaging information conforming to a transmission format providing a status element for carrying the presence status and an inbox element for carrying the message. Several exemplary transmission formats have been described above in conjunction with FIGS. 5A-5C and are included in the illustrative examples of protocol messages provided near the end of this document.

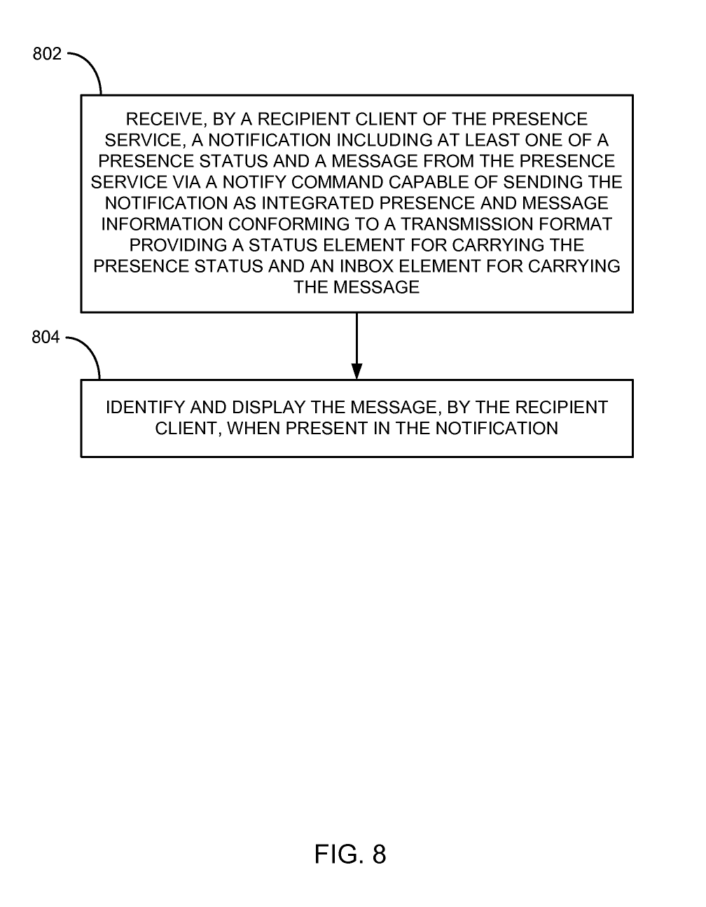

FIG. 8 is a flowchart illustrating a method for receiving messages using a presence service, according to an exemplary embodiment. The method can be carried out using the exemplary system depicted in FIGS. 1 and 3, portions of which are referenced below for illustration purposes.

In block 802, a recipient client of the presence service receives a notification including at least one of a presence status and a message from the presence service via a notify command capable of sending the notification as integrated presence and messaging information. The notify command conforms to a transmission format providing a status element for carrying the presence status and an inbox element for carrying the message.

For example, as described above in conjunction with FIG. 3, the client device 104 further includes a watcher component 308, operatively coupled to the at least one GUI component and the network protocol stack component 302. The watcher component is configured to receive a notification including at least one of a presence status and a message via a notify command. As described above, the notify command is capable of sending the notification in conformance with the transmission format, such as the exemplary data formats shown in FIGS. 5A-5C.

In block 804, the message is identified and displayed by the recipient client when present in the notification. For example, the client device 104 depicted in FIG. 3 is shown to include WUA component 310 configured to translate and route messaging information between a data format known to the watcher component 308 and a data format known to the presence/messaging client 300. The client device 104 depicted in FIG. 3 is shown to also include a messaging GUI component 330 configured to display messages received through the client's 300 WUA component 310.

### Presence/Messaging Data Models

FIGS. 5A-5C illustrate data models for exchanging and/or storing integrated presence and messaging information, according to various exemplary embodiments. Each of the exemplary data models shown includes a status element representing a presence status of at least one client of the presence service. For example, the data models shown in FIGS. 5A-5C include a status element 504 for carrying or storing the status information of a presence service client. The status element 504 can include sub-tuples including additional status information, such as the operational status element 506 shown in the figures. Status information can be carried or stored in a principal's own presence tuple, or can be included in a status element 504 of a shared tuple that has been extended to support publishing the status of a number of presence service clients.

Each of the exemplary data models shown in FIGS. 5A-5C includes an inbox element representing a message for exchange between first and second clients of the presence service. For example, the data models shown in the figures include an instant inbox element/sub-tuple 510. According to an exemplary embodiment, the inbox element 510 can include a session tuple maintained by the presence service for both the first and second clients. The session tuple can include a session element having a session identifier for identifying a messaging session between the first and second clients of the presence service; a first message element associated with one of the presence service clients representing the message; and a second message element associated with the other of the presence service clients representing a second message for exchange between the presence service clients.

For example, FIG. 5C depicts a tuple structure including a separate session sub-tuple 526 within the instant inbox sub-tuple 510 to maintain one or more messaging sessions. The tuple structure shown in FIG. 5C is an exemplary tuple that is compatible with the session tuple 418 discussed in conjunction with FIG. 4C above. Each client device 104 may update the “Instant Inbox” of the session tuple 418 typically by publishing partial tuples to the presence service 110 including only the message element of an instant inbox user/messaging partner sub-tuple, e.g., message elements 514 and 518 of the instant inbox element 510 of the session tuple.

Thus, if the user sub-tuple 512 is associated with client device B 104b, messages for client device B 104b could be published by client device A 104a to the message element 514. Similarly, if the user sub-tuple 516 is associated with client device A 104a, messages for client device a 104a could be published by client device B 104b to the message element 518. Additional user sub-tuples could be added to the instant inbox sub-tuple 510 to allow other users to participate in the messaging session.

In another exemplary embodiment, the data model can include an inbox element 510 having a first tuple maintained by the presence service for the first presence service client including a first message element associated with the second client for carrying the message sent from the first client to the second client; and a second tuple maintained by the presence service for the second presence service client including a second message element associated with the first client for carrying a second message sent from the second client to the first client.

For example, the tuple structure shown in FIG. 5A is an exemplary tuple that is compatible with both the first 400 and second 402 tuples discussed in conjunction with FIG. 4A above. Each tuple owner may update the “Instant Inbox” of his/her/its tuple typically by publishing partial tuples to the presence service 110 including only the message element of an instant inbox user/messaging partner sub-tuple, e.g., message element 514 of the instant inbox element 510 corresponding to User 1. Thus, if the tuple 502 shown in FIG. 5A corresponds to the first tuple 400 for client device A 104a shown in FIG. 4A, then the user sub-tuple 512 could be associated with client device B 104b, and messages for client device B 104b could be published by client device A 104a to the message element 514.

In yet another exemplary embodiment, the data model can include an inbox element 510 having a tuple maintained for one of the first and second clients including a first message element associated with the client for which the tuple is maintained, and a second message element associated with the other client. In a related embodiment, when the tuple is maintained for the first client, the first message element is associated with the second client and is configured to carry the message sent from the first client to the second client, and the second message element is associated with the first client and is configured to carry a second message sent from the second client to the first client.

For example, the tuple structure shown in FIG. 5B is an exemplary tuple that is compatible with the tuple 400 discussed in conjunction with FIG. 4B above. Each client device 104 may update the “Instant Inbox” of the common tuple 400 typically by publishing partial tuples to the presence service 110 including only the message element of an instant inbox user/messaging partner sub-tuple, e.g., message elements 522 and 524 of the instant inbox element 510 corresponding to User 1.

Thus, if the tuple 502 shown in FIG. 5B corresponds to the tuple 400 for client device A 104a shown in FIG. 4B, then the message element 522 could be associated with client device A 104a, and messages for client device A 104a could be published by client device B 104b to the message element 522 (e.g., “User 1 Message”). Similarly, the message element 524 could be associated with client device B 104b, and messages for client device B 104b could be published by client device A 104a to the message element 524. Additional message elements could be added to the instant inbox sub-tuple 510 to allow other users to participate in the messaging session.

### Illustrative Examples of Protocol Messages

The following illustrative examples provide extensions to existing presence and pub-sub tuple structures to support integrated presence and messaging information as can be used in conjunction with the methods and systems described here. The examples use a default XML namespace for illustrative purposes, but persons skilled in the art will understand that other namespaces may be used.

Shown first below are a conventional presence tuple, including presence information, and a conventional instant message, including messaging information, upon which the example extensions that follow are based. The conventional presence tuple is shown in a PIDF format, as specified in RFC 3863, and the conventional instant message is shown in CPIM format, as specified in RFC 3862. As can be seen from the conventional examples, the presence and messaging formats are dissimilar and incompatible with one another.

Presence information in PIDF format:

```
<?xml version=“1.0” encoding=“UTF-8”?>
    <presence xmlns=“urn:ietf:params:xml:ns:pidf”
            entity=“pres:tsmoms@x.com”>
        <tuple id=“rv9x32”>
            <status>
                <basic>open</basic>
            </status>
            <contact priority=“0.8”>tel:+09012345678</contact>
        </tuple>
</presence>
```

Messaging information in CPIM format:

m: Content-type: Message/CPIM

s:

h: From: TOM <im:tsmoms@x.com>

h: To: DICK <im:dsmoms@x.com>

h: DateTime: 2000-12-13T13:40:00-08:00

h: Subject: the weather will be fine today

s:

e: Content-type: text/xml; charset=utf-8

e: Content-ID: <1234567890@foo.com>

e:

e: <body>

e: Here is the text of my message.

e: </body>

The following sample provides an exemplary extension to a SIP SIMPLE presence tuple that can advertise that it supports an IM service with “<message>,”“<inbox>,” and “<options>” methods via the “<servcaps>” method. Note also the “<contact>” method for specifying a communication address for the messaging information.

```
<?xml version=“1.0” encoding=“UTF-8”?>
<presence xmlns=“urn:ietf:params:xml:ns:pidf”
entity=“sip:tsmoms@x.com”>
    <tuple id=“sg89ae”>
        <status>
            <basic>open</basic>
        </status>
        <device-id>mac:8asd7d7d70</device-id>
        <servcaps>
            <methods>
                <method>INBOX</method>
                <method>MESSAGE</method>
                <method>OPTIONS</method>
            </methods>
        </servcaps>
        <contact>sip:gruu-someone-1@x.com</contact>
    </tuple>
    <person>
        <status>
            <activities>
                <activity>on-the-phone</activity>
            </activities>
        </status>
    </person>
    <device device-id=“mac:8asd7d7d70”>
        <status>
            <idle/>
        </status>
    </device>
</presence>
```

The following sample provides exemplary extensions to two related SIP SIMPLE presence tuples supported by the messaging services advertised in the example above. Although not expressly shown, either of the tuples could also contain a “<status>” element illustrating a presence tuple with both presence information and messaging information.

The first related tuple shown below is an exemplary partial presence tuple containing a message to a designated recipient using the “<message>” method advertised for the associated device (also advertised in the example above).

```
<?xml version=“1.0” encoding=“UTF-8”?>
<presence xmlns=“urn:ietf:params:xml:ns:pidf”
entity=“sip:tsmoms@x.com”>
    <tuple id=“sg89ae”>
        <service>
            <device-id>mac:8asd7d7d70</device-id>
                <inbox>
                    <message>
                        <from>TOM</from>
                        <to>DICK sip:dsmoms@x.com</to>
                        <datetime>2006-03-25T08:24:13-05:00
                        </datetime>
                        <subject>Mom</subject>
                        <body>Mom always like you best.</body>
                    </message>
                </inbox>
            </device>
        </service>
    </tuple>
</presence>
```

The second related tuple below shows a partial presence tuple with a reply to the tuple shown above. Note that there is no “<to >” sub-tuple shown in the second tuple, as the service in the example assigned a session ID (“<id>”) to the messaging session. Consequently, the reply can be published to the service using the session ID identifying all of the participants that are to be notified. This arrangement is particularly useful for managing the communications involved in group chat or IM sessions.

```
<?xml version=“1.0” encoding=“UTF-8”?>
<presence xmlns=“urn:ietf:params:xml:ns:pidf”
entity=“sip:dsmoms@x.com”>
    <tuple id=“sg90ae”>
        <service>
            <device-id>mac:8asd7d7d70</device-id>
                <inbox>
                    <message>
                        <id>0x4fc5f</id>
                        <from>DICK</from>
                        <datetime>2006-03-25T08:24:50-05:00
                        </datetime>
                        <subject>Re: Mom</subject>
                        <body>She liked you best.</body>
                    </message>
                </inbox>
            </device>
        </service>
    </tuple>
</presence>
```

The following sample provides exemplary extensions to publish and response XMPP-based pub-sub tuples, as described in JEP-0060. The exemplary publish tuple has been extended with two sub-tuples: a first sub-tuple including presence information (e.g., “<item id=“presence/general”>” having a status element), and a second sub-tuple including messaging information (e.g., “<item id=“inbox”>” having various messaging elements). The exemplary response tuple includes two attributes as extensions allowing the publishing client to be informed that the message previously sent has been assigned to a session with the specified session ID, e.g., 41045.

```
Publisher publishes an item with an “inbox” Item ID:
<iq type=“set” from=“tsmoms@x.com” to=“pubsub.jabber.org”
  id=“tsmoms”>
  <pubsub xmlns=“http://jabber.org/protocol/pubsub”>
    <publish node=“generic”>
      <item id=“presence/general”>
        <status>Asleep</status>
      </item>
      <item id=“inbox”>
        <from>TOM</from>
        <to>DICK dsmoms@x.com</to>
        <datetime>2006-03-25T08:24:13-05:00</datetime>
        <subject>Mom</subject>
        <body>Mom always like you best.</body>
      </item>
    </publish>
  </pubsub>
</iq>
PubSub Server replies indicating success:
<iq type=“result” from=“bigpublishser.com” to=“tsmoms@x.com”
  id=“inbox” session=“41045”/>
```

The following sample provides an exemplary extension to an XMPP pub-sub notification tuple associated with the publish tuple shown above. Note that the session ID has been inserted into the notification tuple allowing subsequent messages to omit the “<to >” element, as the recipients can be identified using the session ID. A subscriber to the publish tuple would receive repeated message notifications in the order in which the messages were published.

```
<message to=“dsmoms” from=“bigpublisher.com”>
    <event xmlns=“http://jabber.org/protocol/pubsub#event”>
        <items node=“general”>
            <item id=“presence/general”>
                <status>Asleep</status>
            </item>
            <item id=“inbox”>
                <session>41045</session>
                <from>TOM tsmoms@x.com</from>
                <to>DICK</to>
                <datetime>2006-03-25T08:24:13-05:00</datetime>
                <subject>Mom</subject>
                <body>Mom always like you best.</body>
            </item>
        </items>
    </event>
</message>
```

The executable instructions of a computer program for carrying out the methods illustrated in FIGS. 6-8 can be embodied in any computer readable medium for use by or in connection with an instruction execution system, apparatus, or device, such as a computer-based system, processor-containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method of exchanging messages via a presence service, the method comprising:
receiving at least one of a presence status and a message sent from a first client of the presence service via a publish command capable of sending the presence status and message as integrated presence and messaging information conforming to a transmission format providing a status element for carrying the presence status and an inbox element for carrying the message; and
sending a notification including at least one of the presence status and at least a portion of the message to a second client of the presence service via a notify command capable of sending the notification in conformance with the transmission format.

2. The method of claim 1, comprising:
creating and maintaining a session tuple for both the first and second clients when a first message for exchange between the first and second clients is generated by one of the presence service clients; and
associating the presence and messaging information with the session tuple;
wherein the session tuple is addressable by a publish command and has a structure corresponding to the transmission format, a corresponding inbox element of the session tuple including a session element having a session identifier for identifying a messaging session between the first and second clients, a first message element associated with one of the presence service clients for carrying the message, and a second message element associated with the other of the presence service clients for carrying a second message.

3. The method of claim 2, comprising subscribing the first and second clients to respective message elements of the session tuple.

4. The method of claim 2, comprising assigning the session identifier to the session tuple, wherein messages exchanged between the first and second clients can be linked via the session identifier.

5. The method of claim 1, comprising:
creating and maintaining a first tuple for the first client when a first message destined for the second client is generated by the first client, and a second tuple for the second client when a first message destined for the first client is generated by the second client; and
associating portions of the presence and messaging information with the first and second tuples;
wherein each of the tuples is addressable by a publish command and has a structure corresponding to the transmission format, a corresponding inbox element of the first tuple including a first message element associated with the second client for carrying the message sent from the first client to the second client and a corresponding inbox element of the second tuple including a second message element associated with the first client for carrying a second message sent from the second client to the first client.

6. The method of claim 5, comprising subscribing the second client to the first message element of the first tuple and subscribing the first client to the second message element of the second tuple.

7. The method of claim 1, comprising:
creating and maintaining a tuple for one of the first and second clients; and
associating the presence and messaging information with the tuple;
wherein the tuple is addressable by a publish command and has a structure corresponding to the transmission format, a corresponding inbox element of the tuple including a first message element associated with the client for which the tuple is maintained, and a second message element associated with the other client.

8. The method of claim 7, wherein the tuple is maintained for the first client, the first message element is associated with the second client and is configured to carry the message sent from the first client to the second client, and the second message element is associated with the first client and is configured to carry a second message sent from the second client to the first client.

9. The method of claim 8, wherein the tuple is created and maintained for the first client and the first and second message elements when a first message destined for the second client is generated by the first client.

10. The method of claim 9, comprising subscribing the second client to the first message element of the tuple and subscribing the first client to the second message element of the tuple.

11. The method of claim 7, comprising restricting access of the client for which the tuple is not maintained to the second message element of the tuple used for carrying messages published to the client for which the tuple is maintained.

12. The method of claim 1, wherein when the second client is not subscribed to the presence and messaging information, the notify command is a directed notify command capable of sending the notification to the second client in conformance with the transmission format.

13. The method of claim 1, comprising sending a notification including at least one of the presence status and at least a portion of the message to each of a plurality of subscribing clients via at least one notify command capable of sending the notifications in conformance with the transmission format.

14. A method of sending messages via a presence service, the method comprising:
generating, by a sender client of the presence service, a message destined for a recipient client of the presence service; and
sending, by the sender client, at least one of a presence status and the message to the presence service via a publish command capable of sending the presence status and message as integrated presence and messaging information conforming to a transmission format providing a status element for carrying the presence status and an inbox element for carrying the message.

15. The method of claim 14, comprising:
creating a tuple, maintained by the presence service for the sender client, when a first message destined for the recipient client is generated by the sender client; and
associating the presence and messaging information with the tuple;
wherein the tuple is addressable by a publish command and has a structure corresponding to the transmission format, a corresponding inbox element of the tuple including a message element associated with the recipient client for carrying the message sent from the sender client to the recipient client.

16. The method of claim 15, comprising subscribing the recipient client to the message element of the tuple.

17. The method of claim 14, wherein generating the message includes providing information identifying a non-subscribing recipient client allowing the message to be sent to the non-subscribing recipient client.

18. The method of claim 14, wherein generating the message includes providing information identifying a subscribing recipient client.

19. The method of claim 14, wherein the message is generated in response to a previous received message associated with a messaging session, and wherein generating the message includes providing a session identifier associated with the messaging session such that the message can be linked to the previous received message.

20. The method of claim 14, wherein the presence service is a local presence service associated with the sender client.

21. A method of receiving messages via a presence service, the method comprising:
receiving, by a recipient client of the presence service, a notification including at least one of a presence status and a message from the presence service via a notify command capable of sending the notification as integrated presence and messaging information conforming to a transmission format providing a status element for carrying the presence status and an inbox element for carrying the message; and
identifying and displaying the message, by the recipient client, when present in the notification.

22. The method of claim 21, comprising identifying the presence status when present in the notification and displaying by the recipient client the presence status.

23. The method of claim 21, wherein the notification is received based on a subscription to the presence and messaging information of a sender client established for the recipient client by the presence service.

24. The method of claim 21, wherein the presence service is a local presence service associated with the sender client.

25. A system for exchanging messages using a presence service, the system comprising:
a data store for storing integrated presence and messaging information; and
at least one presence server including the presence service and a network protocol stack component having a presence protocol layer for communicating with at least one presence service client, the presence service including:
a publication handler component, operatively coupled to the data store, configured to receive at least one of a presence status and a message sent from a first client of the presence service via a publish command capable of sending the presence status and message as integrated presence and messaging information conforming to a transmission format providing a status element for carrying the presence status and an inbox element for carrying the message;
a notification handler component, operatively coupled to the publication hander component and the data store, configured to send a notification including at least one of the presence status and at least a portion of the message to a second client of the presence service via a notify command capable of sending the notification in conformance with the transmission format; and
a router component, operatively coupled to the publication and notification handler components and to the presence protocol layer of the network protocol stack component, the router configured to route the publish and notify commands between the publication and notification handler components and the first and second presence service clients.

26. The system of claim 25, wherein the presence service is configured to:
create and maintain a session tuple in the data store for both the first and second clients when a first message for exchange between the first and second clients is generated by one of the presence service clients; and
associate the presence and messaging information with the session tuple;
wherein the session tuple is addressable by a publish command and has a structure corresponding to the transmission format, a corresponding inbox element of the session tuple including a session element having a session identifier for identifying a messaging session between the first and second clients, a first message element associated with one of the presence service clients for carrying the message, and a second message element associated with the other of the presence service clients for carrying a second message.

27. The system of claim 26, wherein the presence service includes a subscription handler component, operatively coupled to the publication and notification handler components, the data store, and to the router component, the subscription handler component configured to subscribe the first and second clients to respective message elements of the session tuple.

28. The system of claim 26, wherein the presence service is configured to assign the session identifier to the session tuple allowing messages exchanged between the first and second clients to be linked via the session identifier.

29. The system of claim 25, wherein the presence service is configured to:
create and maintain a first tuple in the data store for the first client when a first message destined for the second client is generated by the first client, and a second tuple in the data store for the second client when a first message destined for the first client is generated by the second client; and
associate portions of the presence and messaging information with the first and second tuples;
wherein each of the tuples is addressable by a publish command and has a structure corresponding to the transmission format, a corresponding inbox element of the first tuple including a first message element associated with the second client for carrying the message sent from the first client to the second client and a corresponding inbox element of the second tuple including a second message element associated with the first client for carrying a second message sent from the second client to the first client.

30. The system of claim 29, wherein the presence service includes a subscription handler component, operatively coupled to the publication and notification handler components, the data store, and to the router component, the subscription handler component configured to subscribe the second client to the first message element of the first tuple and subscribe the first client to the second message element of the second tuple.

31. The system of claim 25, wherein the presence service is configured to:
create and maintain a tuple in the data store for one of the first and second clients; and
associate the presence and messaging information with the tuple;
wherein the tuple is addressable by a publish command and has a structure corresponding to the transmission format, a corresponding inbox element of the tuple including a first message element associated with the client for which the tuple is maintained, and a second message element associated with the other client.

32. The system of claim 31, wherein the tuple is maintained by the presence service for the first client, the first message element is associated with the second client and is configured to carry the message sent from the first client to the second client, and the second message element is associated with the first client and is configured to carry a second message sent from the second client to the first client.

33. The system of claim 32, wherein the presence service is configured to create and maintain the tuple for the first client when a first message destined for the second client is generated by the first client.

34. The system of claim 33, wherein the presence service includes a subscription handler component, operatively coupled to the publication and notification handler components, the data store, and to the router component, the subscription handler component configured to subscribe the second client to the first message element of the tuple and subscribe the first client to the second message element of the tuple.

35. The system of claim 32, wherein the presence service is configured to restrict access of the client for which the tuple is not maintained to the second message element of the tuple used for carrying messages published to the client for which the tuple is maintained.

36. The system of claim 25, wherein when the second client is not subscribed to the presence and messaging information, the presence service is configured to use a directed notify command capable of sending the notification to the second client in conformance with the transmission format.

37. The system of claim 25, wherein the presence service is configured to send a notification including at least one of the presence status and at least a portion of the message to each of a plurality of subscribing clients via at least one notify command capable of sending the notifications in conformance with the transmission format.

38. A client device for sending and receiving messages via a presence service, the client device comprising:
a network protocol stack component having a presence protocol layer configured to communicate with the presence service;
at least one graphical user interface (GUI) component configured to gather and present at least one of presence status information and messaging information;
a presentity component, operatively coupled to the at least one GUI component and the network protocol stack component, the presentity component configured to send at least one of a presence status and a message to the presence service via a publish command capable of sending the presence status and message as integrated presence and messaging information conforming to a transmission format providing a status element for carrying the presence status and an inbox element for carrying the message; and
a watcher component, operatively coupled to the at least one GUI component and the network protocol stack component, the watcher component configured to receive a notification including at least one of a presence status and a message via a notify command capable of sending the notification in conformance with the transmission format.

39. The device of claim 38, comprising at least one user agent component configured to translate presence status and messaging information exchanged between the at least one GUI component and at least one of the presentity component and the watcher component.

40. The device of claim 38, comprising a message session manager component, operatively coupled to the at least one GUI component and at least one of the presentity component and the watcher component, the message session manager component configured to assign a session identifier to messages associated with a messaging session, allowing the messages to be linked via the session identifier.

41. The device of claim 38, comprising a roster list monitor component, operatively coupled to the at least one GUI component and the watcher component, the roster list monitor component configured to request subscriptions to and monitor the presence status information of each of the presence service clients associated with entries in a roster list.

42. The device of claim 38, comprising a principal status monitor component, operatively coupled to the at least one GUI component and the presentity component, the principal status monitor configured to monitor activity on the client device and to automatically update the presence status of a principal associated with the client device based on the monitored activity.

43. The device of claim 38, comprising:
a preferences manager component configured to at least one of retrieve, store, and validate settings and options associated with a principal associated with the client device;
a preferences data store, coupled to the preferences manager component, configured to store the principal's preferences and settings; and
a preferences GUI component, coupled to the preferences manager component, configured to present the preferences and settings to the principal and allow the principal to at least one of view and change the preferences and settings.

44. A computer readable medium containing program instructions for exchanging messages via a presence service, the program instructions for:
receiving at least one of a presence status and a message sent from a first client of the presence service via a publish command capable of sending the presence status and message as integrated presence and messaging information conforming to a transmission format providing a status element for carrying the presence status and an inbox element for carrying the message; and
sending a notification including at least one of the presence status and at least a portion of the message to a second client of the presence service via a notify command capable of sending the notification in conformance with the transmission format.

45. A data model for at least one of exchanging integrated presence and messaging information via a presence service and storing the integrated presence and messaging information in a data store, the data model comprising:
a status element representing a presence status of at least one client of the presence service; and
an inbox element representing a message for exchange between first and second clients of the presence service.

46. The data model of claim 45, wherein the inbox element comprises a session tuple maintained by the presence service for both the first and second clients, the session tuple comprising:
a session element having a session identifier for identifying a messaging session between the first and second clients of the presence service;
a first message element associated with one of the presence service clients representing the message; and
a second message element associated with the other of the presence service clients representing a second message for exchange between the presence service clients.

47. The data model of claim 45, wherein the inbox element comprises:
a first tuple maintained by the presence service for the first presence service client including a first message element associated with the second client for carrying the message sent from the first client to the second client; and
a second tuple maintained by the presence service for the second presence service client including a second message element associated with the first client for carrying a second message sent from the second client to the first client.

48. The data model of claim 45, wherein the inbox element comprises a tuple maintained for one of the first and second clients including a first message element associated with the client for which the tuple is maintained, and a second message element associated with the other client.

49. The data model of claim 45, wherein the tuple is maintained for the first client, the first message element is associated with the second client and is configured to carry the message sent from the first client to the second client, and the second message element is associated with the first client and is configured to carry a second message sent from the second client to the first client.

50. A system for exchanging messages using a presence service, the system comprising:
means for storing integrated presence and messaging information;
means for receiving at least one of a presence status and a message sent from a first client of the presence service as integrated presence and messaging information conforming to a transmission format providing a status element for carrying the presence status and an inbox element for carrying the message; and
means for sending a notification including at least one of the presence status and at least a portion of the message to a second client of the presence service in conformance with the transmission format.
